(19) United States
(12) Patent Application Publication
(10) Pub. No.: US 2004/0186740 A1
(43) Pub. Date: Sep. 23, 2004

(54) Method of trading information

(76) Inventors: Daisuke Katsuta, Yokohama (JP); Mineo Nomoto, Yokohama (JP); Michiaki Kurosaki, Ibaraki (JP); Tetsuo Taguchi, Hitachi (JP); Shihei Yamashita, Hitachi (JP); Isao Tanaka, Tokai (JP); Masahiro Hotta, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/733,316

(22) Filed: Dec. 12, 2003

(30) Foreign Application Priority Data
Dec. 13, 2002 (JP) 2002-361596

(51) Int. Cl. G06F 17/60

(52) U.S. Cl. 705/1

(57) ABSTRACT

The present invention relates to a method which provides reliable image information that makes it possible to perform external inspections for defects in the welded parts of piping and the like using images such as movie images, still images and the like. Using a digital camera, digital video camera or the like, the reliability of images can be increased by adding information such as the time and place of imaging, air temperature, humidity, altitude, environment, sounds and the like to images. Furthermore, since imaging data is transmitted to a data managing company via the internet or the like immediately after imaging, the possibility of falsification by the person performing the imaging or the like is eliminated, so that the reliability of the images is increased, thus making it possible to obtain highly reliable image information.

### BACKGROUND OF THE INVENTION

1. Field of the Invention

The present invention relates to a method for trading image information such as still images, movie images or the like via communications means such as the internet or the like, and more particularly relates to a method for trading image information in which the reliability of the image information, such as the authenticity of the information, prevention of falsification of the information and the like, is improved, and industrial products to which this image information is appended.

2. Description of the Related Art

Conventionally, in the handling of images and image information in the field of information communications, and especially on the internet, various methods for preventing falsification have been proposed in order to prevent copyright violations and the like. For example, measures for preventing falsification such as encoding using the inverse function of a one-way function based on a decryption key on images input from a digital image recording apparatus and the like are described in Japanese Patent Application Laid-Open No. H11-98461.

Such electronic signature methods are security systems for images that are transmitted and received via the internet or the like; however, such systems have no effect in cases where a falsification is made prior to the electronic signature processing that is performed before the data is stored in the PC used for anti-falsification processing from the digital image recording apparatus prior to transmission or reception.

As an example of the application of image information, in cases where the welded portions of metal parts are inspected by a non-destructive inspection, an inspection that is performed in order to discover fissures, cracks or the like occurring in the welded portions of such metals or the like is currently accomplished by means of a visual inspection performed by an inspector. A non-destructive method in which an inspection for defects in the welded surfaces is performed using digital images or the like relating to the metal surfaces is conceivable as a means of rationalizing such an inspection.

In cases where an inspection is performed by transmitting such image information via the internet, it is necessary to ensure the reliability and authenticity of the image information that is inspected, as to whether or not this information comprises images that were obtained by properly imaging the object, and whether or not the images were falsified.

Specifically, in order to perform various types of inspections using image information as typified by digital still images, it is necessary to make it possible to confirm that the images have not been falsified from a time immediately following the imaging of the images by an imaging device such as a digital camera or the like.

### SUMMARY OF THE INVENTION

The present invention provides a method of trading image information which makes it impossible to falsify images once these images have been imaged, and which makes it possible to confirm that such images have not been falsified following imaging.

Specifically, in the present invention, the place and time at which images are obtained can be clearly specified by receiving a JJY standard frequency transmitted from Communications General Laboratories or a GPS (global positioning system) satellite wave, and adding accurate and precise information regarding time and place to the image information, so that reliable image information is obtained. Furthermore, the reliability of such image information can be further increased by adding imaging information regarding air temperature, humidity, altitude, environment, sound and the like. Moreover, the method of the present invention is devised so that data that allows identification of the camera used in imaging and the person performing this imaging can also be added to the image information.

Furthermore, falsification can be prevented by a circulation system in which the image information is controlled and circulated by a specified organization or association, and various types of visual inspections or the like can be widely rationalized in all types of fields as a result of the acquisition of reliability by such image information.

These and other objects, features and advantages of the invention will be apparent from the following more particular description of preferred embodiments of the invention, as illustrated in the accompanying drawings.

### BRIEF DESCRIPTION OF THE DRAWINGS

FIG. 1 shows one embodiment in which the image information of the present invention is applied to a piping installation;

FIG. 2 shows one embodiment in which the image information of the present invention is applied to a construction project;

FIG. 3 shows one embodiment in which the image information of the present invention is applied to food processing;

FIG. 4 shows one embodiment of image acquisition means which make it possible to create the image information of the present invention;

FIG. 5 shows one embodiment of image acquisition means which make it possible to create the image information of the present invention;

FIG. 6 shows one embodiment of the construction of a system for trading the image information of the present invention;

FIG. 7 is a flow chart which shows one example of the flow of information in a system for trading the image information of the present invention;

FIG. 8 is a flow chart which shows another example of the flow of information in a system for trading the image information of the present invention;

FIG. 9 is a flow chart which shows another example of the flow of information in a system for trading the image information of the present invention;

FIG. 10 shows one embodiment of the information search system of the present invention;

FIG. 11 shows one embodiment in which the image information of the present invention is applied to the prevention of falsification of images;

FIG. 12 shows one embodiment of image acquisition means which make it possible to create the image information of the present invention; and

FIG. 13 shows one embodiment of an inspection warning to which image information of the present invention has been appended.

### DESCRIPTION OF THE PREFERRED EMBODIMENTS

Embodiments of the present invention will be described below with reference to the attached figures.

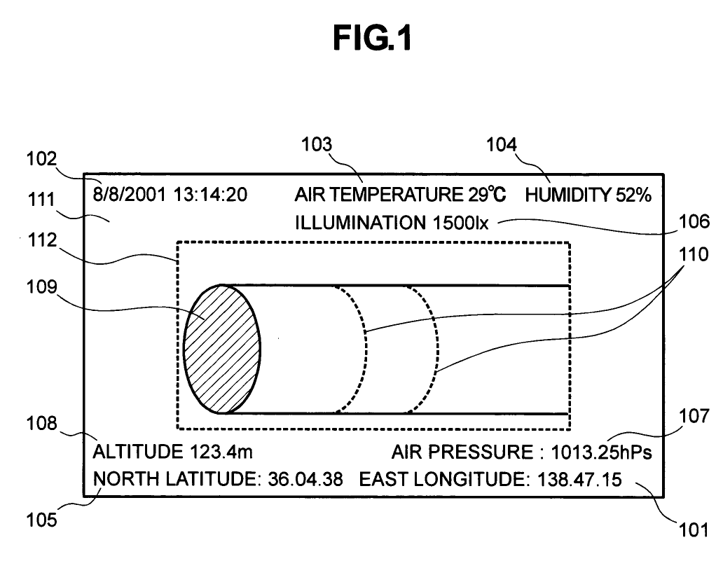

FIG. 1 shows an example in which information regarding the conditions of a welding inspection of metal piping 109 which is used in a large installation such as a generating plant or the like, and which is imaged by means of a digital camera, is expressed as image information of the present invention. In this metal piping 109, three pipes are connected by welding; 110 indicates the welding marks. In order to inspect for welding defects in the welding marks 110, a penetrating damage-locating test treatment is performed, and defective areas such as fissures, cracks or the like can be observed by means of a red pattern.

Furthermore, it would also be possible to perform a magnetic powder damage-locating treatment instead of a penetrating damage-locating treatment. In this case, the regions including the welding marks 110 are illuminated with ultraviolet light, and the fluorescence generated by defective areas such as fissures, cracks or the like is detected.

In regard to the installation image information 101, along with an image of the metal piping 109, imaging time information 102, position information 105 indicating the imaging location in terms of latitude and longitude, imaging environment information acquired at the time of imaging such as air temperature information 103, humidity information 104, illumination information 106, air pressure information 107 and altitude information 108, an identification code (not shown in the figures) for the digital camera used, the name and identification code (not shown in the figures) of the person performing the imaging and the like are displayed in an environmental information region 111 within the same image.

The time information 102 displays a value obtained by receiving a JJY standard frequency. Furthermore, in the case of the location information 105, highly precise information from a GPS satellite wave is acquired, calculated and recorded. In the still images of the digital camera of this example, environmental information is added at the time of imaging; in the case of moving images, however, environmental information during image recording is continuously written.

The time information and position information is highly reliable information as a result of the use of accurate and precise information which is public information. For example, in FIG. 1, the location of the plant in which the metal piping 109 was present, and the location of the installation within the plant, can be specified from the position information 105 obtained from a GPS satellite wave. Furthermore, the manufacturing method process through which the metal piping 109 was passing at the time of imaging can be ascertained from the time information 102. As a result, the origin of the installation image information 101 is clear in terms of which piping was in which state, so that this information is endowed with reliability. As a result of the information relating to place and time thus being strictly specified, the images constitute information in an extremely limited narrow space, and therefore have a genuineness that allows no room for the entry of other falsifying factors, so that the images have a high added value.

To describe this in detail, when the time information 102 of the installation image information 101 of the present embodiment is compared with a manufacturing process table (not shown in the figures) or the like of the metal piping 109, it can be confirmed that the current state is a welding inspection state. Furthermore, from the position information 105 and a layout diagram (not shown in the figures) of the interior of the plant or the like, it can also be confirmed which part of which installation contained the piping parts, and it can be verified from the time and position information that the installation image information 101 does not comprise spurious images.

By using the highly reliable image information of the present invention, it is possible to perform an inspection for defects in the welding marks 110 indirectly using the installation image information 101. In conventional inspections for defects, in welding marks, an inspector possessing the necessary qualifications for performing such inspections repeatedly visits the site of the piping and makes a visual inspection; however, if image information is used, instantaneous transfer is possible, so that inspection and confirmation can be accomplished without the inspector being on-site. Even in a remote location, an inspector can perform an inspection for defects by looking at the welding marks 110 in installation image information 101 that is displayed on a screen or printed out.

Furthermore, a quantitative evaluation of a defect inspection can be performed instead of a visual inspection by performing a defect inspection using image processing from images in the image region 112. In this case, in order to perform image processing with a correct evaluation of the resolution of the images imaged by the digital camera, the installation image information 101 must include an image obtained by imaging a resolution evaluation sample with the digital camera along with an image of the welding marks 110.

Furthermore, for example, in cases where defects or problems are discovered following the completion of the installation of the metal piping 109, the cause of such problems can be inferred from the information regarding air temperature 103, humidity 104, air pressure 107 and altitude 108 within the installation image information 101, so that the installation image information 101 also has a high utility value in terms of maintenance.

Furthermore, in cases where changes in the metal piping 109 over time are monitored using the installation image information 101, new installation image information 101 at the current point in time can be obtained under the same conditions as at the time of previous imaging by calling up previously imaged and stored installation image information 101, and using the information regarding the data and time of previous imaging and environmental conditions at the time of previous imaging that is recorded in this previous installation image information 101. As a result, a plurality of sets of installation image information 101 imaged over time can be compared in a simple manner, so the changes in the metal piping 109 over time can easily be evaluated.

In regard to methods used to call up previously imaged and stored installation image information 101, a personal computer connected to the internet or a mobile telephone equipped with an internet function may be used. The installation image information 101 that is called up is displayed on the screen of the personal computer or mobile telephone.

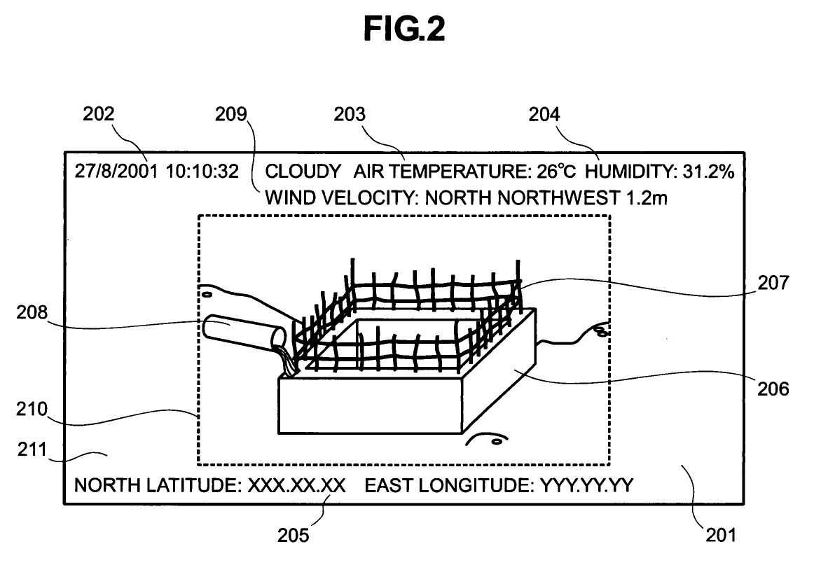

FIG. 2 shows an example in which the construction of the foundation of a building is expressed as image information of the present invention from construction processes imaged by a digital camera. In the construction image information 201, the conditions of the construction of the foundation part 206 of a building that in under construction outdoors are displayed together with environmental information regarding the time 202, air temperature 203, humidity 204, wind velocity 209, and latitude and longitude 205. This environmental information indicates the following: first of all, the position 205 indicates which building is involved, and the time 202 indicates the conditions of progress in the construction process. Accordingly, the images and the building can easily be compared.

Furthermore, using the time information 202, confirmation can be made from the number of steel re-bars 207 and the like in the foundation part 206 of this building as to whether or not construction standards such as the required number of re-bars and the like have been satisfied. Moreover, if the distribution of the hardening material 208 is recorded in images at the same time, concerns about strength on the part of the builder can be assuaged, and doubts about illegal construction can also be eliminated, so that the reliability of the building can be backed up. Furthermore, anxiety and distrust can be eliminated by disclosing such information to the builder, nearby populace and the like during construction.

If damage or failure should occur for some reason following the completion of the construction shown in the construction image information 201, this information may constitute important data for investigating the effects of the environment on the building in an elucidation of causes and the like from the air temperature 203, humidity 204 and wind velocity 209.

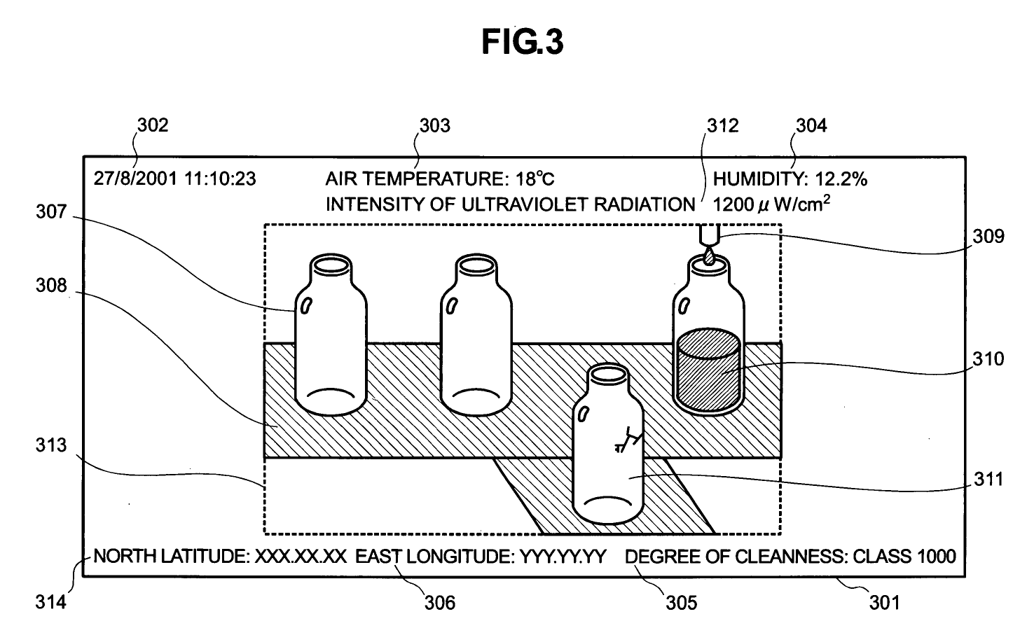

FIG. 3 shows an example in which the manufacturing process of a food product imaged by a digital camera is expressed as image information of the present invention. In this food product image information 301, the conditions of the manufacturing process in a food processing plant in which a processed beverage 310 is sealed in glass containers 307 on a conveyor 308 are displayed along with environmental information regarding the time 302, air temperature 303, humidity 304, intensity of ultraviolet radiation 312, degree of cleanness 305 and latitude and longitude 306.

The environmental information indicates the following: first, the year, month and day of manufacture can be confirmed from the time 302, and the manufacturing plant can be confirmed from the place 306. As a result, in cases where some type of abnormality occurs in the shipped beverage product, the image information is effective in elucidating the causes of this abnormality. Furthermore, hygiene conditions such as the possibility of the generation of bacteria or the like can be ascertained from the air temperature 303, humidity 304, intensity of ultraviolet radiation 312 and degree of cleanness 305. In addition, the inspection conditions can be ascertained from the conditions of separating out of defective glass containers 311. Furthermore, such information leads to improved reliability of the product by the disclosure of information under normal circumstances, and not just in the case of abnormalities.

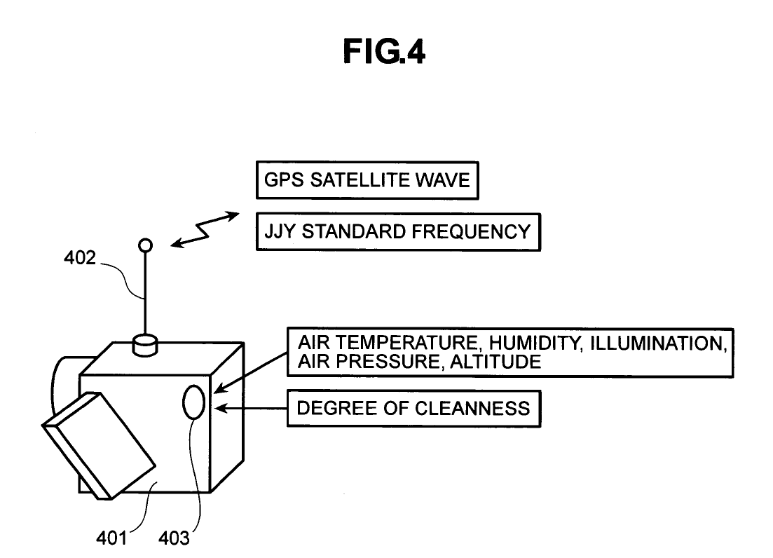

FIG. 4 shows an example in which image acquisition means that can be used to create the image information of the present invention are expressed as a digital camera. The image acquisition means 401 contain a digital camera, and are equipped with an antenna 402. A GPS satellite wave is received by the antenna 402, so that the position of the digital camera 401 can be ascertained in terms of longitude and latitude. Furthermore, the accurate imaging time is obtained by receiving a JJY standard frequency.

Moreover, image acquisition means 401 contain numerous types of sensors 403, and the air temperature, humidity, illumination, air pressure, altitude, degree of cleanness and the like are measured by these sensors 403. Such information can also be acquired from the antenna 402 rather than from sensors 403. The digital camera 401 incorporates such information into the images at the time of imaging; furthermore, this image information may be sent to a storage destination via the internet or the like from the antenna 402.

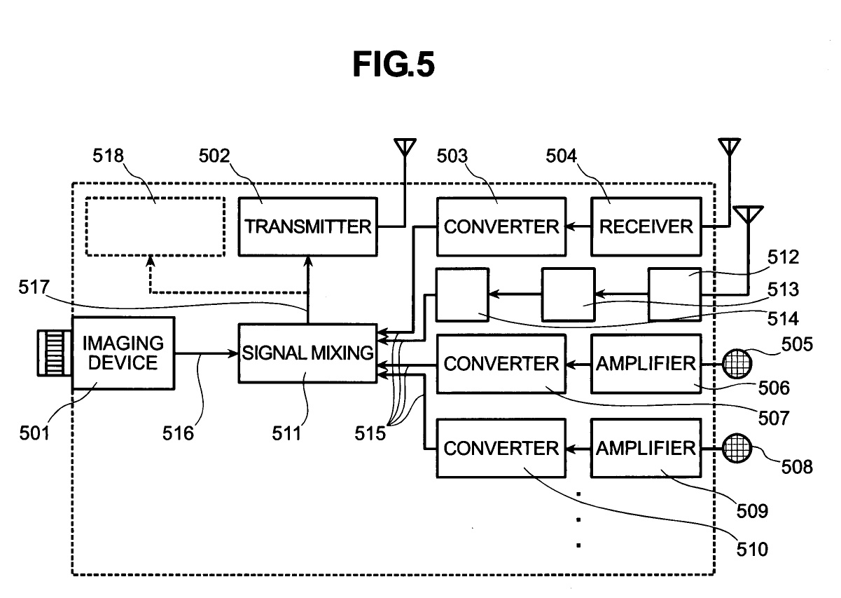

FIG. 5 shows an example in which the construction of the image acquisition means 401 shown in FIG. 4 is expressed as a block diagram.

The images are input by means of an imaging device 501. For example, this imaging device 501 is a digital camera, digital video camera, DVD camera or the like. Simultaneously with image input, a standard frequency JJY indicating the standard time is received by a standard time signal receiver 504, and the time value of this signal is converted into an image signal format by a character converter 503. Similarly, a GPS satellite wave is received by a satellite wave receiver 512, latitude and longitude values are calculated from this wave signal by a calculator 513, and these values are converted into an image signal format by a character converter 514.

Furthermore, also input simultaneously with the image input are signals from a temperature sensor 505 and a humidity sensor 508. The sensor outputs are converted into digital numerical values by respective sensor amplifiers 506 and 509, and are converted into an image signal format by character converters 507 and 510. Sensors may be added in accordance with the items that are measured.

The output information signals 515 of the character converters 503, 507 and 510 that convert the respective waves and sensor values into an image signal format are synthesized with the image signal 516 from the imaging device 501 by an image signal mixer 511, and all of this information is incorporated in the image, thus producing image information 517.

The image information 517 is sent out from an image transmitter 502, and is transferred via the internet. Alternatively, the image information 517 is stored in a read-only memory 518. In order to prevent falsification by the party performing the imaging, this memory 518 is constructed as a read-only memory which does not allow overwriting once writing has been performed.

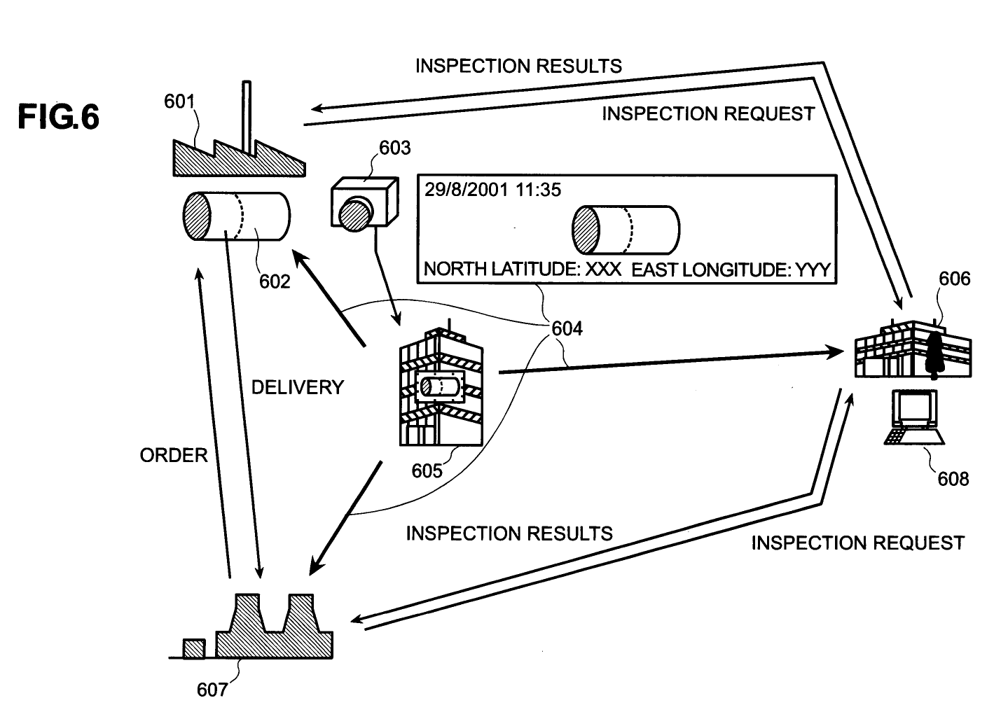

FIG. 6 is a model diagram of the image information trading method of the present invention using a plant facility as an example.

This piping plant 601 manufactures piping products 602 in accordance with orders from customers 607 (e.g., a generating plant). In the piping plant 601, inspection conditions for the completed piping product 602, or inspection conditions during manufacture, are imaged by a digital camera 603. The digital camera 603 can create image information of the present invention, and piping image information 604 in which environmental information regarding the time of imaging and the position, air temperature and the like during imaging is incorporated into the acquired images constitutes a commercial product.

Information such as an image of a resolution evaluation sample acquired by the digital camera 603 for the purpose of correctly evaluation the resolution of the images, as well as camera identification data that specifies the digital camera 603 used for imaging, identification data that identifies the person performing the imaging and the like, is also added to this piping image information 604.

After this piping image information 604 has been subjected to anti-falsification processing such as the electronic signature processing disclosed in “PGP Code Mail and Electronic Signatures, Encryption for Everyone” by Simson Garfinkel (O'Reilly Japan Inc.), or the image watermark processing disclosed in “Electronic Watermarks and Protection of Contents” by Tsukasa Ono (Ohm-sha), the information is electronically transmitted to an image information managing company 605, and is stored.

However, if an electronic watermark or the like is added to the image portion of the image information, there may be cases in which the original image is lost, so that accurate processing results cannot be obtained by image processing. As a countermeasure against this problem, there are methods in which the imaging means are not provided with an image recording medium for preserving the captured image. In cases where there is no image recording medium for preserving the captured image in the digital camera 603, image information cannot be accumulated. Instead, the piping image information 604 is sent to the image information managing company 605 via the internet or the like immediately after imaging, and is stored by this company. Accordingly, images do not remain at hand in the piping plant 601, and falsification is made impossible by the control of the image information managing company 605, so that the images constitute image information with a high degree of authenticity and reliability, and image processing is also possible.

An independent inspection organization 606 which uses the image information 604 to perform an inspection for the presence or absence of surface defects in the piping product 602 acquires the image information 604 from the image information managing company 605 via the internet or the like in accordance with inspection requests from the piping plant 601 or customer 607, and performs an inspection for surface defects using an image processing system 608. The results of the inspection processing are reported via the internet or the like to the piping plant 601 or customer 607 where the request originated.

In cases where defects are discovered in the inspection results, information regarding the defects is reported to the customer 607 via the internet together with an image of the sample surface that contains these defects. Since the customer 607 can ascertain the quality of the product to be purchased according to the inspection results beforehand, the risk to which the customer 607 is exposed can be reduced; furthermore, in the case of the piping plant 601, since reliability can be ensured by selling the product with the inspection results appended to the product, the added value is increased.

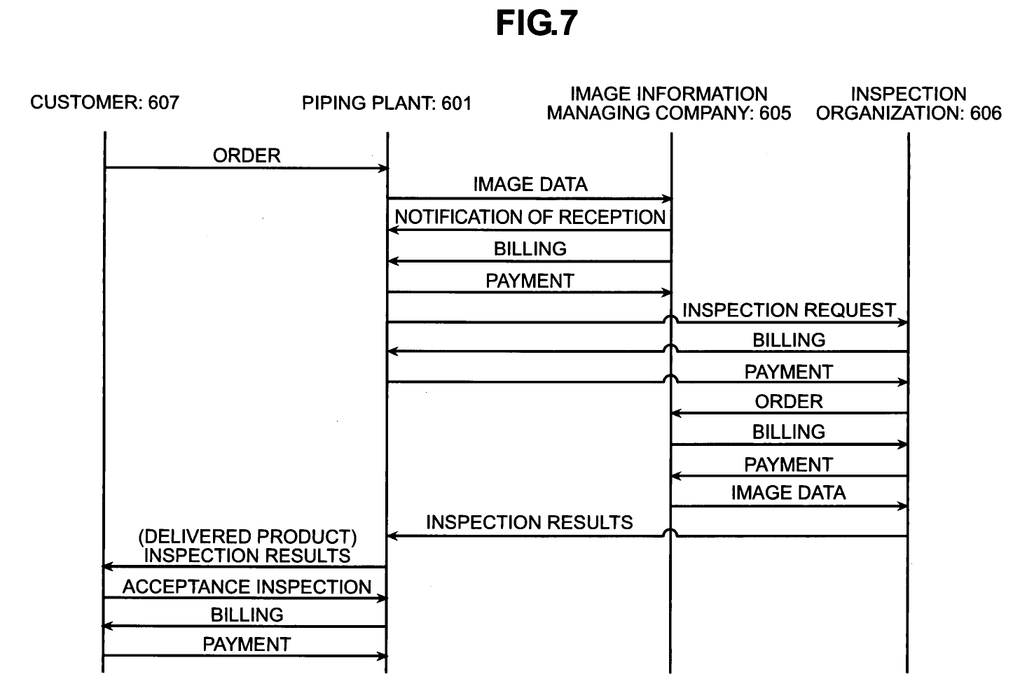

The flow of information in the abovementioned system will be described with reference to FIG. 7.

First, a customer 607 order the manufacture of a piping product from the piping plant 601. The piping plant 601 images the piping product for which an order has been received at an intermediate stage during manufacture and upon the completion of manufacture by means of a digital camera 603, and transmits the image information 604 to the image information managing company 605 via the internet.

The image information managing company 605 notifies the sender on the side of the piping plant 601 that the image data has been received, and charges the piping plant 601, via the internet, a fee corresponding to the amount of transmitted image information 604.

The piping plant 601 pays the requested fee to a designated financial institution, and the image information 604 is registered and stored at the time that this payment is confirmed. Furthermore, the charging and payment of fees need not be performed for each transmission of image information 604; such charging and payment may be performed periodically on a consolidated basis.

Next, the piping plant 601 issues a request for inspection to the inspection organization 606 via the internet. After confirming that the piping plant 601 has been charged, and that payment has been received from the piping plant 601, the inspection organization 606 that has received the request for inspection orders the registered image information 604 from the image information managing company 605 via the internet.

After charging a fee for the order from the inspection organization 606 and confirming that payment has been received, the image information managing company 605 transmits the image information 604 to the inspection organization 606 via the internet.

The inspection organization 606 receiving the image information 604 from the image information managing company 605 performs an inspection for surface defects using an image processing system 608, and transmits the inspection results via the interned to the piping plant 601 where the request originated.

The piping plant 601 that receives the inspection results also sends data regarding the inspection results received from the inspection organization 606 to the customer 607 via the internet at the time that the completed piping product is delivered to the customer 607. When the piping plant 601 receives notification of a passing inspection grade from the customer 607, the piping plant 601 submits a request for payment of charges, and the charges are paid by the customer.

The system shown in FIG. 7 is one example, and the method and timing of billing and payment performed among the piping plant 601, image information managing company 605, inspection organization 606 and customer are not limited to this example. For example, billing and payment need not be performed at the time of each request or order; such billing and payment may be handled periodically on a consolidated basis.

Furthermore, data regarding inspection results need not always be sent via the internet at the time that the completed product is delivered to the customer 607 from the piping plant 601; for example, data in hard copy form may be appended at the time that the product is delivered.

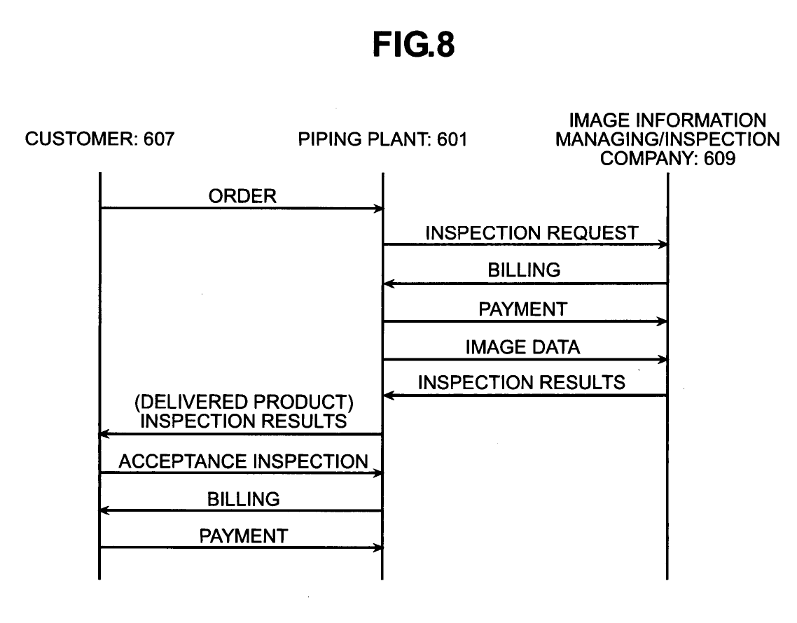

FIG. 8 shows the flow of data in the system shown in FIG. 6 in a state in which the image information managing company 605 and inspection organization 606 are integrated.

In this case, the piping plant 601 receiving an order from the customer 607 sends a request to an image information managing/inspection company 609 (in which the image information managing company 605 and inspection organization 606 in FIG. 8 are integrated) to perform an inspection of the ordered piping product in an intermediate stage of manufacture, and in the stage of the completed product.

After charging a fee and receiving payment from the piping plant 601 where the request originated, the image information managing/inspection company 609 receiving the inspection request receives image information 604 for inspection use from the piping plant 601, performs an inspection for surface defects using the image processing system 608 shown in FIG. 6, and transmits the inspection results via the internet to the piping plant 601 where the request originated.

The piping plant 601 that receives the inspection results also sends data concerning the inspection results received from the inspection organization 606 to the customer 607 via the internet at the time that the completed piping product is delivered to the customer 607. When the piping plant 601 receives notification of a passing inspection grade from the customer 607, the piping plant 601 submits a request for payment of charges, and the charges are paid by the customer.

In the example shown in FIG. 8, as in the example shown in FIG. 7, the method and timing of billing and payment performed among the piping plant 601, image information managing/inspection company 609 and customer are not limited to this example.

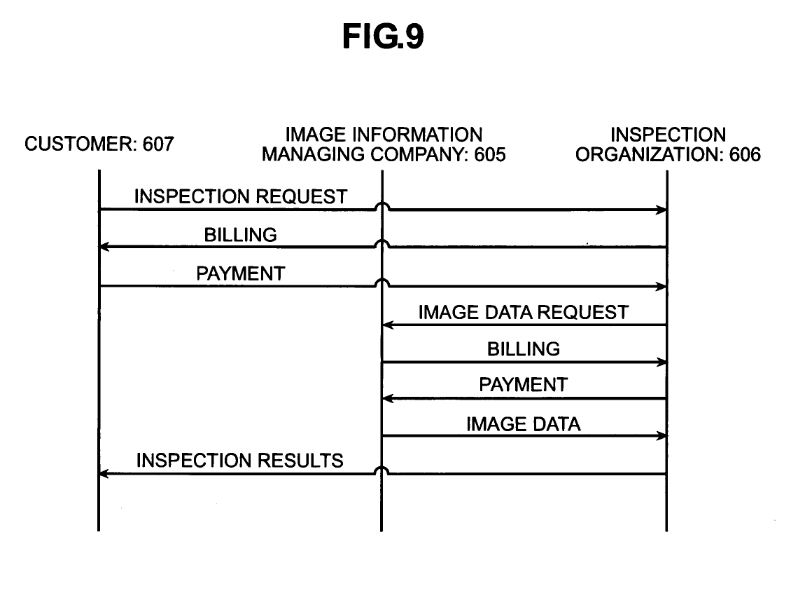

FIG. 9 shows one example of the flow of data in a case where a piping product that has been purchased from the piping plant 601 and used is periodically inspected.

After confirming payment from the customer 607, the inspection organization 606 that has received an inspection request from the customer 607 orders image information 604 for the corresponding product from the imaging information managing company 605. The imaging information managing company 605 that receives this order transmits image information 604 for the corresponding product that has been stored, and image information 604 for the same product that is newly acquired by the digital camera 603 to the inspection organization 606.

Here, by referring to information relating to the imaging environment recorded in the image information 604 for the corresponding product that has been stored when new image information 604 for the product is acquired by the digital camera 603, it is possible to acquire image information 604 for the product at the current point in time in the same imaging environment as that of the image information 604 that has been stored.

The inspection organization 606 that has received the image data performs an inspection for surface defects using the image processing system 608 shown in FIG. 6, and transmits the inspection results via the internet to the customer 607 that originated the request. The customer 607 receiving the inspection results can continue to use the piping product after confirming the safety of the piping product. Furthermore, in accordance with the demands of the customer 607, the inspection company 606 can also retrieve previous inspection results corresponding to the current inspection results from the storage means (data server), and can send these previous inspection results to the customer 607 as data that is appended to the current inspection results.

In the example shown in FIG. 9, the imaging information managing company 605 and inspection organization 606 were described as separate organizations; however, it would also be possible to combine these into a single organization as in the case of the image information managing/inspection company 609 shown in the example illustrated in FIG. 8. In this case, the customer 607 sends a request for inspection to a company A (not shown in the figures) such as the image information managing/inspection company 609 shown in FIG. 8. Company A that receives this request performs an inspection for surface defects using product image data stored at its own location and product image data that has been newly acquired using the digital camera 603, this inspection being accomplished by means of the image processing system 608 shown in FIG. 6. Company A then transmits the inspection results via the internet to the customer 607 that originated the request.

The request for inspection that is sent to the inspection organization 606 may also come from a third party other than the piping plant 601 or customer 607. For example, in a case where the customer 607 is a nuclear power generating plant, a request for inspection may also be made by persons having doubts regarding the facility such as the surrounding populace or the like. Furthermore, it would also be possible to acquire image information 604 directly from the image information managing company 605 without sending a request to the inspection organization 606, and to perform independent inspection processing. The image information managing company 605 is operated by obtaining payment for the management of the image information 604 from the originator of requests for this image information 604, e.g., the piping plant 601, customer 607 or the like.

By using such a system, it is possible to achieve an increase in the efficiency of inspections in fields where large machined products, cast products or the like are repeatedly inspected.

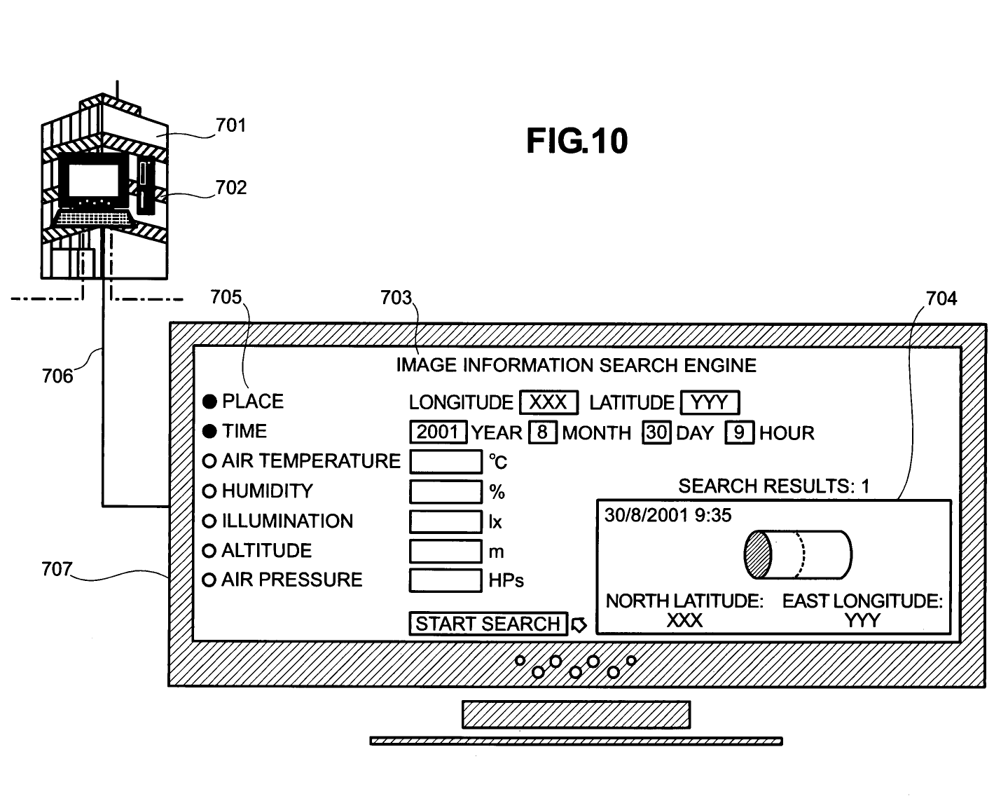

FIG. 10 shows one embodiment of an image information search system constructed according to the present invention.

Here, image information is collected and managed in an image information memory device 702 at a image information managing company 701. The image information managing company is operated on the basis of charges for managing the information and transaction sales figures. In cases where only desired image information is to be extracted from the image information held by the image information managing company 701, an image information search system 703 provided by the image information managing company is used. The image information search system 703 can be called up and operated from a PC 707 that is connected to the image information managing company 701 via the internet 706. When the image information search system 703 is operated, a table of information items 705 is displayed. Information constituting key words is selected from these information items 705, and the content is input. For example, in cases where a confirmation of a surface inspection is to be performed for a purchased piping product, the location of the plant where the piping was manufactured and the approximate date and time are input into the image information search system 703.

The image information search system 703 that has received a search command searches for image information candidates that match the input information in the image information memory device 702, and displays simple images of the candidate image information as search results 704 on the PC 707 that requested the search.

As another search example, there may be cases in which a quality check of piping for which delivery is planned is performed. In cases where the effects of humidity during a certain period on the product in question are to be investigated, this can be accomplished by selecting the location of the manufacturing plant, the time of manufacture and the humidity from the information items 705 of the image information search system 703, and inputting arbitrary numerical values. In cases where the desired image information is found in the search results 704, this image information is purchased from the image information managing company 701. In the case of image information whose purchase is desired by a transaction partner, the image information managing company 701 sells the complete image information to the transaction partner via the internet 706. The party that receives the complete image information can perform various types of inspections on the basis of the image information, either visually or by using image processing.

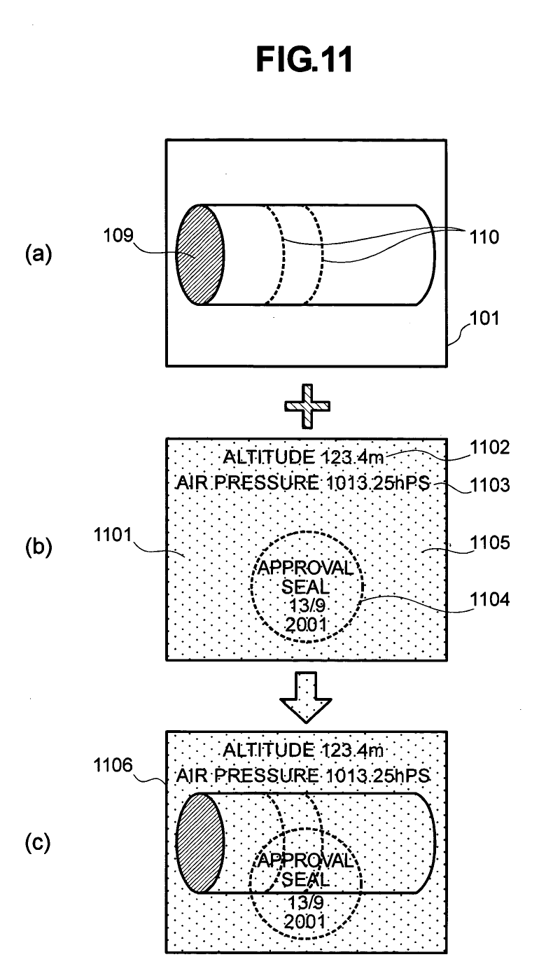

FIG. 11 shows one embodiment in which the image information of the present invention is applied to the prevention of image falsification.

Like FIG. 1, FIG. 11A shows installation image information 101 for metal piping 109 on which a penetrating damage-locating test treatment has been performed, and which has been imaged by means of a digital camera for the purpose of making an inspection for welding defects in the welding marks 110. FIG. 11B shows watermark digital image information 1101 for an electronic watermark constituting one procedure of anti-falsification means for digital images. FIG. 11C shows image information 1106 in which the electronic watermark of FIG. 11C is embedded in FIG. 11A.

An electronic watermark is something that is embedded by (for example) adding known data to the entire surface of an image for which the prevention of falsification is desired. In cases where the image is falsified following the embedding of the watermark, the falsification can be detected by virtue of the fact that the embedded information is changed when the embedded information is read out. The concrete watermark processing may use the Primary Watermark technique of the Galaxy Group (joint proposal by IBM, NEC, SONY and Hitachi).

The watermark digital image information 1101 expresses the embedded information as image information. The embedded information of the watermark digital image information 1101 comprises altitude information 1102 and air pressure information 1103 for the place where the installation image information 101 of (a) was imaged, graphic information 1104 which shows an approval seal that notes the date of the penetrating damage-locating test performed on the welding marks 110 of the installation image information 101, and shade information 1105 which uses a numerical value determined by the coordinates of the image in the background as a brightness density value. Furthermore, in the shade information 1105, the positions where the numerical value data of the altitude information 1102 and air pressure information 1103 are embedded as several bits of embedded information may be determined and disposed using statistical procedures.

Judgement of the possible falsification of the image information 1106 in which an electronic watermark is embedded is accomplished as follows: namely, digital image information corresponding to the watermark digital image information 1101 is read out from the image information 1106 (following watermark embedding) by performing processing that is the opposite of the processing that embedded the watermark digital image information 1101, and the embedded information of the read-out digital image is compared with the known information that is embedded in the watermark digital image information 1101. If these two sets of information disagree by even one bit, it is judged that falsification has occurred.

In the case of the image information 1106 in which the electronic watermark of (c) is embedded, the embedded watermark information is in a visible state. However, it would also be possible to embed this information in an invisible state. In this case, the resistance of the image in processing such as rotation or enlargement of the image is weakened; however, the information may have reversibility that allows reproduction of the image prior to embedding.

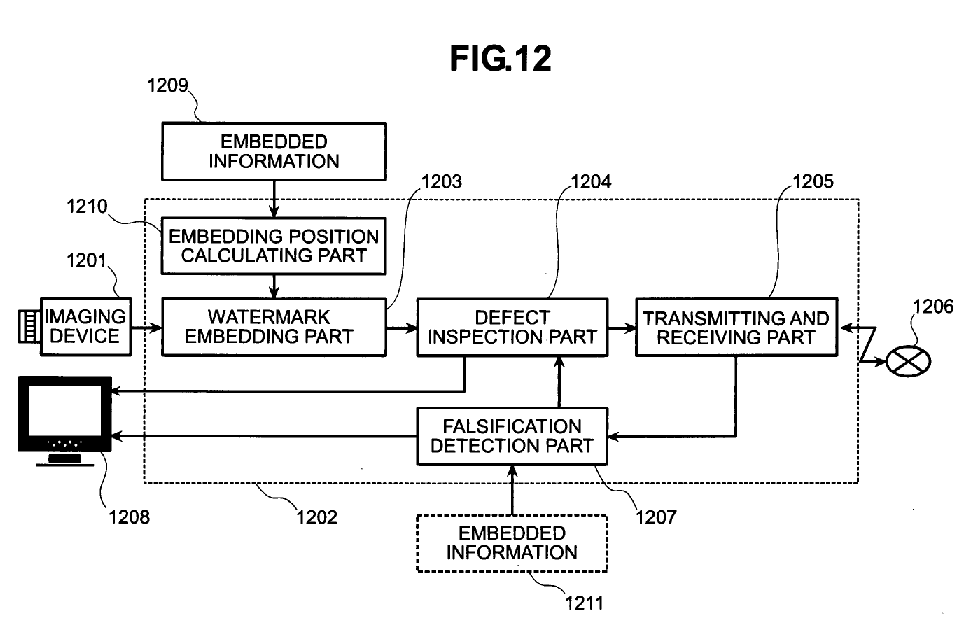

FIG. 12 shows one embodiment of image acquisition means that can create image information used in the prevention of image falsification of the present invention.

Here, a defect inspection device 1202 that performs a penetrating damage-locating test inputs digital image data that images an inspection area coated with a penetrating liquid and a developing agent from an imaging device 1201 such as a digital camera or the like. In the defect inspection device 1202, electronic watermark processing is performed on the image data immediately following image input. For example, the embedding position of 8-bit embedded information 1209 such as preset characters, figures or the like is determined by the embedding position calculating part 1210 using a statistical procedure.

In the watermark embedding part 1203, the embedded information is embedded in the input image according to the data of the embedding position calculating part 1210.

Since the electronic watermark used in the present device is used for the purpose of detecting falsification, this watermark need not have any resistance to processing such as image alteration, editing, compression or the like, and a watermark of the invisible and low-resistance type in which there is no great change in the input image data is desirable. As a result of the embedding of this electronic watermark, the presence or absence of image falsification can be detected b the defect inspection device 1202.

Next, the image data that has been subjected to electronic watermark processing is inspected for the presence or absence of defects in a penetrating damage-locating test performed by the defect inspection part 1204. In cases where defects are found, inspection results such as the location and size, area, shape, hue, saturation, brightness and the like of the defects are stored in memory, and the defect inspection results are displayed on a display device 1208 such as a monitor or the like. Afterward, the image data that has been subjected to image falsification preventive processing is transmitted along with the defect inspection results to other locations from the transmitting and receiving part 1205 via a network 1206 or the like. Furthermore, the transmitting and receiving part 1205 also receives image data sent from other locations.

The received image data is checked for the presence or absence of falsification by the falsification detection part 1207. In the case of this image data, embedded information is read out for image data (in which the electronic watermark has been processed) by the falsification detection part 1207. In cases where read-out is impossible, or in cases where the information that is read out differs from the known embedded information 1211, it is judged that the image in question has been falsified.

The results of this check for the presence or absence of falsification are displayed on the display device 1208 (such as a monitor or the like). Furthermore, for received images that are free of falsification, defect inspection processing of the abovementioned penetrating damage-locating test is performed by the defect inspection part 1204.

An electronic signature (or digital signature) using a hush function instead of the electronic watermark technique can also be used as a tool for prevent the falsification of the digital image data.

By thus using image acquisition means that can create the image information of the present invention as image information that prevents the falsification of images, it is possible to guarantee freedom from image falsification in digital images that are easily falsified and thus ordinarily lack reliability. Accordingly, such images and defect inspection results for these images can be endowed with a high degree of reliability, and visual inspections such as penetrating damage-locating tests and the like can be replaced by indirect visual inspections using images.

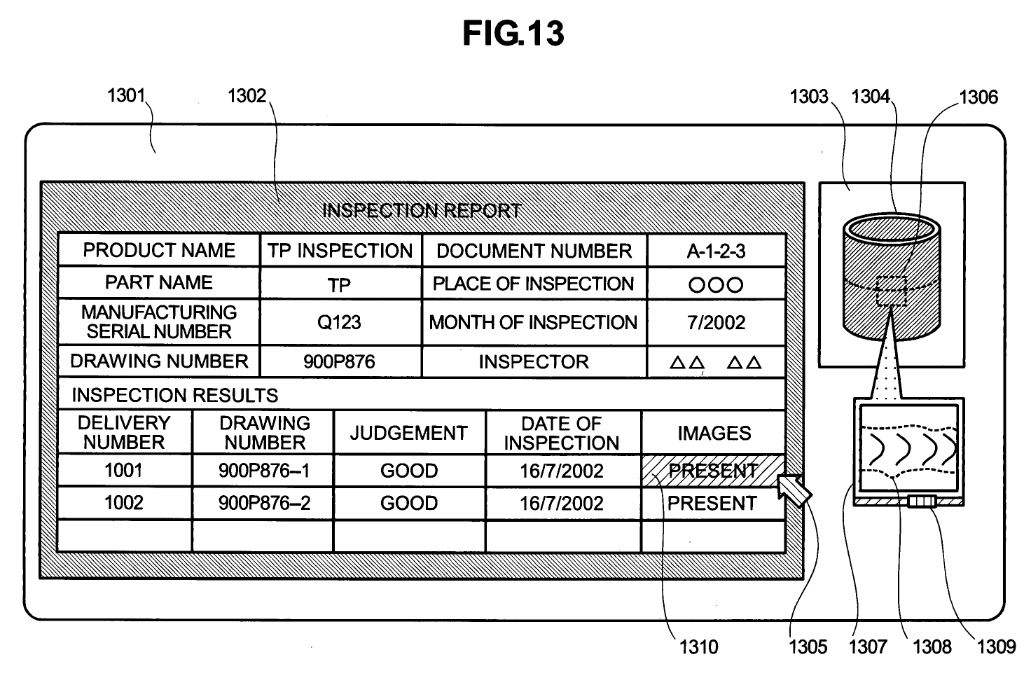

FIG. 13 shows one embodiment of an inspection report to which image information of the present invention is appended.

The results of a damage-locating test inspection of the welded parts in a piping product 1304 are displayed in the format of an inspection report 1302 on a monitor screen 1301. The format of the inspection report 1302 note the product name, part name, manufacturing serial number, drawing number, document number, place of inspection, month of inspection and name of the inspector. Below, the judgement results for good parts and defective parts are displayed as inspection results along with the inspection date for each drawing number of the piping product. If there are no defects in the welded state so that the part is good, “good” is displayed in the column for the judgement results. Furthermore, the presence or absence of image information imaging each piping part is displayed in the image presence or absence column 1310.

In cases where the image presence or absence column 1310 displays “present”, this indicates that one or more sets of image information relating to the inspection results are linked with the inspection report 1302. When this image presence or absence column 1310 is clicked on by the cursor 1305, the image data display window 1303 displays the image information for the piping part 1304 that is stored in memory along with the inspection report 1302.

Furthermore, in the detail window 1307, details of the welded state of the piping part 1304 are displayed in an enlarged form. The detail window 1307 shows an enlarged display of the region indicated in the detail display range 1306 of the image data display window 1303. A scroll bar 1309 is provided in the detail image window 1307, and arbitrary welded portions can be displayed by moving this scroll bar to the left or right using the cursor 1305. By observing the welded state 1308 of the piping product 1304 that is the object of inspection in images in which these welded parts are enlarged, it is possible to reproduce in these images the conditions under which a judgement of good or defective was made in the inspection report 1302.

If an inspection report to which the image information of the present invention is appended is used, the addition of image information to an inspection report consisting only of character information makes it impossible to report false inspection results, so that the inspection report can be endowed with a high degree of reliability.

The present invention can solve the following conventional problem points:

(1) By adding image time information and position information indicating the imaging location, as well as environment information such as the air temperature, humidity and the like at the time of imaging, to the same image, image information with high reliability and a high added value can be obtained, and this information can be utilized as information for non-destructive inspections using images, monitoring of various types of manufacturing processes, and [other types of] process monitoring.

(2) In image acquisition means such as a digital camera or the like, by eliminating an image memory medium such as flash memory or disk memory for preserving the captured image information and transmitting the image information to a data managing company immediately following imaging, it is possible to eliminate any possibility of falsification by the person performing the imaging or the like, so that the authenticity of the images is guaranteed and highly reliable image information is obtained.

(3) By adding image information recording the manufacturing process, inspection conditions and the like to products, it is possible to back up product quality, so that the products can be endowed with a high degree of reliability.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method for trading image information comprising the steps of:
imaging an object using camera means so that a digital image of said object is acquired;
preparing digital image information in which information relating to the place and time at which said object was imaged, and information relating to the environment, are added to said acquired digital image; and
transmitting said prepared digital image information via communications means, and further receiving on the transmission side of said digital image information, via said communications means, information from the reception side of said digital image information confirming that said information has been transmitted, and receiving payment for said output digital image information from a customer.

2. The method for trading image information according to claim 1, wherein said information relating to the place and time at which said object was imaged comprises longitude and latitude information received from a GPS, and standard time information.

3. The method for trading image information according to claim 1, wherein said information relating to the place where said object was imaged comprises one or more types of information selected from air temperature, humidity, illumination, intensity of ultraviolet radiation, altitude, air pressure, wind velocity, degree of cleanness and sound.

4. The method for trading image information according to claim 1, wherein the name or code number of a person performing the imaging who acquired said digital image is further added to said digital image information.

5. A method for trading image information comprising the steps of:
calling up a digital image which has been acquired by imaging an object of inspection, and which has been stored in memory means along with the imaging environment conditions at the time that said digital image was imaged, via communications means;
displaying the imaging environment conditions at the time that the called-up digital image was imaged on a screen;
imaging said object of inspection in accordance with said displayed imaging environment conditions;
adding information relating to the imaging environment conditions at the time of said imaging to the digital image obtained by said imaging;
transmitting the digital image to which said information relating to the imaging environment conditions has been added to the reception side via communications means; and
receiving payment for said transmitted digital image from a customer.

6. The method for trading image information according to claim 5, wherein said imaging environment conditions include the place and time where said object was imaged, the person who performed the imaging, and information relating to the environment at the place where said imaging was performed.

7. The method for trading image information according to claim 5, wherein said information relating to the environment at the location where said imaging was performed includes any of air temperature, humidity, illumination, intensity of ultraviolet radiation, altitude, air pressure, wind velocity, degree of cleanness and sound.

8. A method for trading image information comprising the steps of:
imaging parts in which metals are welded so that a digital image of said welded parts is obtained;
preparing digital image information by adding to said acquired digital image imaging environment conditions at the time when said digital image was acquired;
transmitting said prepared digital image information to the reception side via communications means;
detecting defects in said welded parts from said digital image information that is received on the reception side;
outputting information relating to detected defects in said welded parts along with an image of said welded parts including said defects; and
receiving payment from a customer for said output information relating to said defects in the welded parts and said image of the welded parts.

9. The method for trading image information according to claim 8, wherein said digital image of welded parts acquired by imaging said parts in which metals are welded is a digital image of parts in which metals are welded which have been subjected to a penetrant test processing or a magnetic particle test processing.

10. The method for trading image information according to claim 8, wherein said imaging environment conditions include the place and time where said object was imaged, the person who performed the imaging, and information relating to the environment at the place where said imaging was performed.

11. The method for trading image information according to claim 8, wherein said information relating to the environment at the location where said imaging was performed includes any of air temperature, humidity, illumination, intensity of ultraviolet radiation, altitude, air pressure, wind velocity, degree of cleanness and sound.

12. The method for trading image information according to claim 8, wherein defects in said welded parts are detected by subjecting said digital image to image processing.

13. A method for trading image information comprising the steps of:
acquiring a digital image of welded parts obtained by imaging metal welded parts, along with data relating to the imaging environment conditions at the time that said digital image was imaged, via communications means;
detecting defects in said metal welded parts from said acquired digital image;
outputting information relating to said detected defects in said welded parts along with an image of said welded parts including said defects via communications means; and
receiving payment from a customer for said output information relating to defects in said welded parts and said image of said welded parts.

14. The method for trading image information according to claim 13, wherein said digital image of welded parts acquired by imaging said parts in which metals are welded is a digital image of parts in which metals are welded which have been subjected to a penetrant test processing or a magnetic particle test processing.

15. The method for trading image information according to claim 13, wherein said imaging environment conditions include the place and time where said object was imaged, the person who performed the imaging, and information relating to the environment at the place where said imaging was performed.

16. The method for trading image information according to claim 13, wherein said information relating to the environment at the location where said imaging was performed includes any of air temperature, humidity, illumination, intensity of ultraviolet radiation, altitude, air pressure, wind velocity, degree of cleanness and sound.

17. The method for trading image information according to claim 13, defects in said welded parts are detected by subjecting said digital image to image processing.

18. A method for trading image information comprising the steps of:
receiving a digital image obtained by imaging an object of inspection, along with data relating to the imaging environment conditions including GPS information relating to the location where said digital image was imaged, via communications means;
inspecting said object of inspection by subjecting said received digital image to image processing;
transmitting information obtained by said inspection to the customer via communications means; and
receiving payment for said transmitted information obtained by said inspection from a customer.

19. The method for trading image information according to claim 18, wherein said object of inspection is a member in which metals are welded, which has been subjected to a penetrant test processing or a magnetic particle test processing, and said inspection of said object of inspection by subjecting said received digital image to image processing comprises the detection of defects in said metal welded parts.

20. The method for trading image information according to claim 18, wherein said information relating to the environment at the location where said imaging was performed includes any of air temperature, humidity, illumination, intensity of ultraviolet radiation, altitude, air pressure, wind velocity, degree of cleanness and sound.

21. A method for trading image information comprising the steps of:
receiving a digital image obtained by imaging an object of inspection, along with data relating to the imaging environment conditions at the time that said digital image was imaged and an image obtained by imaging resolution evaluation samples, via communications means;
inspecting said object of inspection using said received digital image and said image of resolution evaluation samples;
transmitting information obtained by said inspection to the customer via communications means; and
receiving payment for said transmitted information obtained by said inspection from said customer.

22. The method for trading image information according to claim 21, wherein said object of inspection is a member in which metals are welded, which has been subjected to a penetrant test processing or a magnetic particle test processing, and said inspection of said object of inspection by subjecting said received digital image to image processing comprises the detection of defects in said metal welded parts.

23. The method for trading image information according to claim 21, wherein said information relating to the environment at the location where said imaging was performed includes any of air temperature, humidity, illumination, intensity of ultraviolet radiation, altitude, air pressure, wind velocity, degree of cleanness and sound.

24. A method for trading image information comprising the steps of:
imaging an object by camera means so that a digital image of said object is obtained;
preparing digital image data in which one or more sets of digital image information are added to said acquired digital image; and
transmitting said prepared digital image information via communications means, receiving on the transmission side of said digital image information, via communications means, information from the reception side of said digital image information confirming that said information has been transmitted, and receiving payment for said transmitted digital image information from a customer.

25. The method for trading image information according to claim 24, wherein digital image information detects alterations of said digital image.

26. The method for trading image information according to claim 24, wherein said digital image information includes information relating to whether or not falsification has occurred subsequent to the preparation of the digital image information.

27. The method for trading image information according to claim 24, wherein said digital image information is electronic watermark information in which characters or figures are embedded in said digital image.

28. The method for trading image information according to claim 24, wherein said character or figure information embedded by electronic watermark processing includes any information relating to the place, time or environment of the imaging of said digital image.

29. The method for trading image information according to claim 24, wherein said digital image information is an electronic signature in which said digital image is converted into a summary by a hush function, and the summary is encoded using an encoding key.

30. A method for trading image information comprising the steps of:
imaging parts in which metals are welded, so that a digital image of said welded parts is acquired;
preparing digital image information by adding one or more sets of digital image information that have image falsification preventing means;
detecting defects in said welded parts from said digital image information;
displaying image information relating to said detected defects; and
outputting information relating to said detected defects along with an image of said welded parts including said defects via communications means; and
receiving payment for said output information relating to said defects and said images of the welded parts from a customer.
